(19) United States
(12) Patent Application Publication
(10) Pub. No.: US 2003/0037297 A1
(43) Pub. Date: Feb. 20, 2003

(54) Frame synchronization device and frame synchronization method

(76) Inventor: Hirofumi Araki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/023,928

(22) Filed: Dec. 18, 2001

(30) Foreign Application Priority Data
Aug. 15, 2001 (JP) 2001-246662

(51) Int. Cl. H04L 1/00

(52) U.S. Cl. 714/746

(57) ABSTRACT

The present invention provides a frame synchronization device for receiving frames and establishing frame synchronization. The frame synchronization device attempts to detect a first synchronization data in a received data in a frame hunting state, and enters a synchronous state when the first synchronization data is detected for a first predetermined number of consecutive frames. The device corrects errors of the data in the frame based on a check data in the frame. And the device attempts to detect a second synchronization data in the corrected frame, and returns to the frame hunting state when the second synchronization data is not detected.

### BACKGROUND OF THE INVENTION

1. Field of the Invention

The present invention relates to a frame synchronization device and frame synchronization method for receiving frames and establishing frame synchronization.

2. Description of the Related Art

Recent years have seen increases in communication speeds and increases in information-carrying capacity through wavelength division multiplex (WDM) and other technologies. As an example, FIG. 9 shows the format of the frames of transmission signals, transmitted at speeds of several gigabits per second (Gbps) to several terabits per second (Tbps) over submarine optical fiber cables.

This frame (hereafter called “frame A”) has an overhead portion A1, information portion A2, and check (inspection) portion A3. The overhead portion A1 contains information necessary for code error correction, information necessary for operation and maintenance, and other control information; at the beginning of the overhead portion A1 is provided a frame word “a” (frame signal, synchronization word, synchronization data), which is information to indicate the beginning of a frame. The frame word a may consist, for example, of a unique pattern or other code.

The information portion A2 contains the user information or similar to be transmitted. This information may for example be multiplexed by means of the synchronous digital hierarchy (SDH); the information portion A2 includes one or more frames B each having an overhead portion B1 and information portion B2.

The check portion A3 contains code error correction information to correct code errors in a frame which occur during transmission (for example, a Reed-Solomon (RS) code).

On the other hand, it has become difficult to ensure quality of transmission simultaneously with higher transmission speeds and larger capacity. In order to resolve this problem, each year methods of transmission code error correction using the code error correction information of the check portion A3, enabling recovery of low-transmission quality signals, are developed and adopted.

However, as prerequisites to perform such error correction, the reception equipment must detect the beginning position of the received frame A, and frame synchronization to receive frames with accurate reception timing must be established.

FIG. 10 is a state transition diagram showing a frame synchronization method performed by a receiver for receiving such frames A.

First, in an asynchronous state in which frame synchronization is not established, the receiver is in a frame hunting state 100, and attempts to detect a frame word a at the beginning position of a frame A.

When a frame word a is detected (OK in the state 100), the receiver enters backward alignment guard states 101 to 10n. In backward alignment guard states, judgments are made as to whether, in the states from the backward first stage (state 101) to the backward nth stage (state 10n), the frame word can be detected in each of n frames succeeding from the frame in which frame hunting is performed. Because the frame length is determined in advance, detection of frame words in each of the n succeeding frames is performed by determining the beginning position of the next frame based on this length, and examining whether or not a frame word was detected at this position. The value of n is determined in advance; for example, n=2 may be set.

If no frame word is detected in any of these backward alignment guard operations (the result is NG for all of the states 101 to 10n), the receiver again returns to the frame hunting state 100.

The frame hunting state 100, and the backward alignment guard states 101 to 10n, are regarded as asynchronous states in which frame synchronization is not yet established. In this backward alignment guard state, received frames are discarded.

In backward alignment guard, when frame words are detected for n consecutive stages, the receiver enters the synchronous state 200. In this synchronous state 200 also, detection of the frame words of subsequent frames is continued, and when frame words are detected (OK in state 200), the synchronous state is maintained. On the other hand, if a frame word is not detected while in the synchronous state (NG in state 200), the receiver enters a state of forward alignment guard for m stages (states 201 to 20m). The value of m is set in advance; for example, m=4 may be set.

In a forward alignment guard state, if frame words are not detected for m consecutive subsequent frames (NG in state 20m), the receiver leaves the synchronous state and returns again to the asynchronous state. Frame hunting is then performed (state 100).

In a forward alignment guard state, when a frame word is detected (OK in any of states 201 to 20m), the receiver returns to the synchronous state 200.

A frame received while in a synchronous state (including forward alignment guard states) is not discarded, and subsequently is processed by the receiver. This processing includes error correction processing based on code error correction information.

However, due to a decline in transmission quality accompanying faster transmission speeds, the probability that data other than frame words will be erroneously changed to a frame word increases. Consequently there is an increased possibility that the receiver may synchronize in error (pseudo-synchronize, erroneously synchronize) with frame words arising due to code errors, or with patterns which coincidentally are the same as frame words.

On the other hand, the probability that a code error will occur in a frame word itself also increases. If a code error thus occurs in a frame word, it often happens that the synchronous state that had once been established is lost, and there is a return to the asynchronous state.

In such a state, despite the fact that the quality of transmission signals can be improved using the powerful code error correction functions of recent years, the synchronous state cannot be maintained, and so error correction is not performed, the frame is discarded, and effective communication becomes impossible.

### SUMMARY OF THE INVENTION

An object of the present invention is to provide a frame synchronization device and frame synchronization method to establish more accurate frame synchronization.

The frame synchronization device according to a first aspect of the present invention is a frame synchronization device, which receives data communicated on a transmission line and establishes frame synchronization by means of frames containing, at least, first and second synchronization data for establishing frame synchronization and check data for correcting errors of data in the frame, said first and second synchronization data being disposed at prescribed positions within the frame, comprising: a first frame synchronization unit for attempting to detect said first synchronization data within said received data in a frame hunting state in which frame synchronization is not established, and entering a synchronous state in which frame synchronization is established when said first synchronization data is detected in said prescribed position for a first predetermined number of consecutive frames; an error correction unit for correcting errors of data in the frame based on said check data in the frame when said first synchronization data is detected by said first frame synchronization unit; and a second frame synchronization unit for attempting to detect said second synchronization data at said prescribed position within the frame corrected by said error correction unit, and returning said first synchronization unit to said frame hunting state when said second synchronization data is not detected.

In this first aspect of the invention, in the frame hunting state in which frame synchronization has not been established, an attempt is made to detect the first synchronization data within the received data. When the first synchronization data is detected in the prescribed position for a first number, determined in advance, of consecutive frames, the first frame synchronization unit enters a synchronous state in which frame synchronization is established. Also, errors of data contained in a frame having a detected first synchronization data are corrected, based on the check data contained in the frame. Then an attempt is made to detect the second synchronization data at the prescribed position within the frame after correction. If the second synchronization data is not detected, the first frame synchronization unit returns to the frame hunting state.

In this way, by means of the first aspect of this invention, even when frame synchronization is established based on data before code error correction, if frame synchronization is not established based on data after error correction, the first frame synchronization unit is returned to the frame hunting state. As a result frame synchronization can be performed more accurately, and pseudo-synchronized (erroneously synchronized) states can be prevented.

The frame synchronization device according to a second aspect of the present invention is a frame synchronization device, which receives data communicated on a transmission line and establishes frame synchronization by means of frames containing, at least, first and second synchronization data for establishing frame synchronization and check data for correcting errors of data in the frame, said first and second synchronization data being disposed at prescribed positions within the frame, comprising: a first frame synchronization unit for attempting to detect said first synchronization data at said prescribed position in said received frame in a synchronous state in which frame synchronization is established, and entering an asynchronous state in which frame synchronization is not established when said first synchronization data is not detected for a first predetermined number of consecutive frames; an error correction unit for correcting code errors of data in said received frame based on said check data in the frame; and a second frame synchronization unit for attempting to detect said second synchronization data at said prescribed position in the frame corrected by said error correction unit, and putting said first synchronization unit into said asynchronous state when a second predetermined number of said second synchronization data is/are not detected consecutively.

In the second aspect of the present invention, in a synchronous state in which frame synchronization is established, an attempt is made to detect the first synchronization data at the prescribed position within the received frame. If the first synchronization data is not detected for a first number, determined in advance, of consecutive frames, the first frame synchronization unit enters an asynchronous state in which frame synchronization is not established. Also, errors of data contained in the received frame are corrected based on the check data contained in the frame. Then an attempt is made to detect the second synchronization data at the prescribed position within the corrected frame, and if the second synchronization data is not detected for a second number, determined in advance, the first frame synchronization unit enters an asynchronous state.

Thus in the second aspect of this invention, even in a state in which frame synchronization is once established, if at least one of the two frame synchronization data from before and after error correction is not detected, the synchronous state is cancelled. As a result, the frame synchronous state can be maintained more accurately after establishment of frame synchronization, and in addition pseudo-synchronization (erroneous synchronization) states can be prevented.

The frame synchronization device according to a third aspect of the present invention is a frame synchronization device, which receives data communicated on a transmission line and establishes frame synchronization by means of frames containing, at least, a synchronization data for establishing frame synchronization and check data for correcting errors of data in the frame, said synchronization data being disposed at a prescribed position within the frame, comprising: a first frame synchronization unit for attempting to detect said synchronization data within said received data in a frame hunting state in which frame synchronization is not established, and entering a synchronous state in which frame synchronization is established when said synchronization data is detected at said prescribed position for a first predetermined number of consecutive frames; an error correction unit for correcting errors of data in the frame having the detected synchronization data based on said check data in the frame if said synchronization data is detected by said first frame synchronization unit; and a second frame synchronization unit for attempting to detect said synchronization data at said prescribed position in the frame corrected by said error correction unit, and returning said first synchronization unit to said frame hunting state if said synchronization data is not detected.

In this third aspect of the invention also, similarly to the above first aspect, even if frame synchronization is established based on data prior to code error correction, if frame synchronization is not established based on data after code error correction, the first frame synchronization unit is returned to the frame hunting state. By this means frame synchronization can be performed more accurately, and pseudo-synchronization (erroneous synchronization) states can be prevented.

The frame synchronization device of a fourth aspect of the present invention is a frame synchronization device, which receives data communicated on a transmission line and establishes frame synchronization by means of frames containing, at least, a synchronization data for establishing frame synchronization and check data for correcting errors of data in the frame, said synchronization data being disposed at a prescribed position within the frame, comprising: a first frame synchronization unit for attempting to detect said synchronization data at said prescribed position of said received frame in a synchronous state in which frame synchronization is established, and entering an asynchronous state in which frame synchronization is not established when said synchronization data is not detected for a predetermined number of consecutive frames; an error correction unit for correcting errors of data in said received frame based on said check data in the frame; and a second frame synchronization unit for attempting to detect said synchronization data at said prescribed position in the frame corrected by said error correction unit, and putting said first synchronization unit into said asynchronous state when said synchronization data is not detected for said predetermined number of consecutive frames.

In this fourth aspect of the invention also, similarly to the above second aspect, even in a state in which frame synchronization is once established, if a frame synchronization data is not detected in at least once before and after correction of code errors, the synchronous state is cancelled. By this means the frame synchronization state can be maintained more accurately after establishment of frame synchronization, and pseudo-synchronization (erroneous synchronization) states can be prevented.

### BRIEF DESCRIPTION OF THE DRAWINGS

FIG. 1 is a block diagram showing the configuration of transmission device in a first embodiment of this invention;

FIG. 2 is a block diagram showing the configuration of the reception device 2 according to the first embodiment of the present invention;

FIG. 3 is a flowchart showing the flow of processing of the frame synchronization circuit 21 and original signal frame synchronization circuit 29 of the reception device 2;

FIG. 4 is a block diagram showing the configuration of reception device according to a second embodiment of the present invention;

FIG. 5 is a flowchart showing the flow of processing of a first frame synchronization circuit 31 and second frame synchronization circuit 32 of the reception device 3;

FIG. 6 is a block diagram showing the configuration of the transmission device according to a third embodiment of this invention;

FIG. 7 is a block diagram showing the configuration of the reception device 5 of the third embodiment of this invention;

FIG. 8 is a flowchart showing the flow of processing of the first frame synchronization circuit 51 and second frame synchronization circuit 52 of the reception device 5;

FIG. 9 shows the format of the frames of transmission signals, transmitted at speeds of several gigabits per second (Gbps) to several terabits per second (Tbps) over submarine optical fiber cables; and

FIG. 10 is a state transition diagram showing a frame synchronization method performed by a receiver for receiving such frames A.

### DESCRIPTION OF THE PREFERRED EMBODIMENTS

First Embodyment

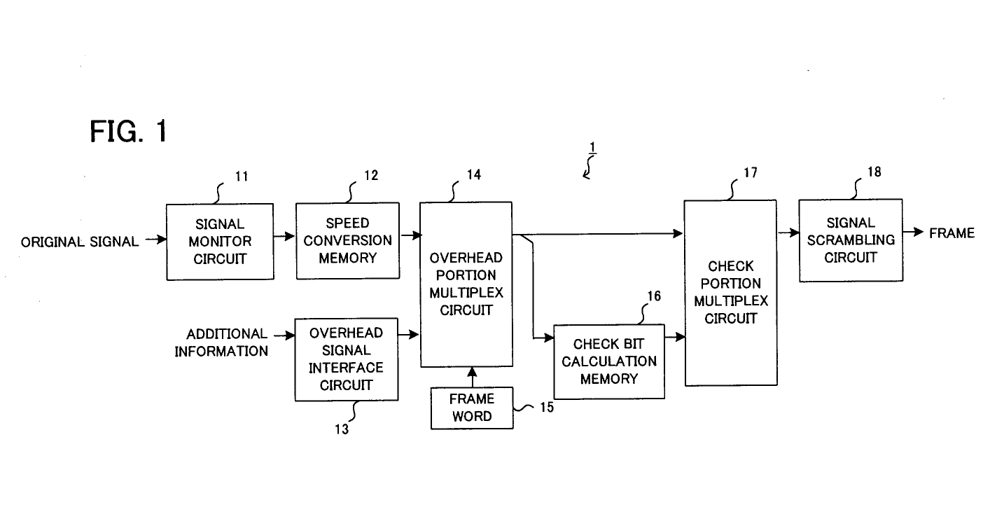

FIG. 1 is a block diagram showing the configuration of transmission device 1 in a first embodiment of this invention.

This transmission device 1 has a signal monitor circuit 11, speed conversion memory 12, overhead signal interface circuit 13, overhead portion multiplex circuit 14, frame word generation circuit 15, check bit calculation circuit 16, check portion multiplex circuit 17, and signal scrambling circuit 18.

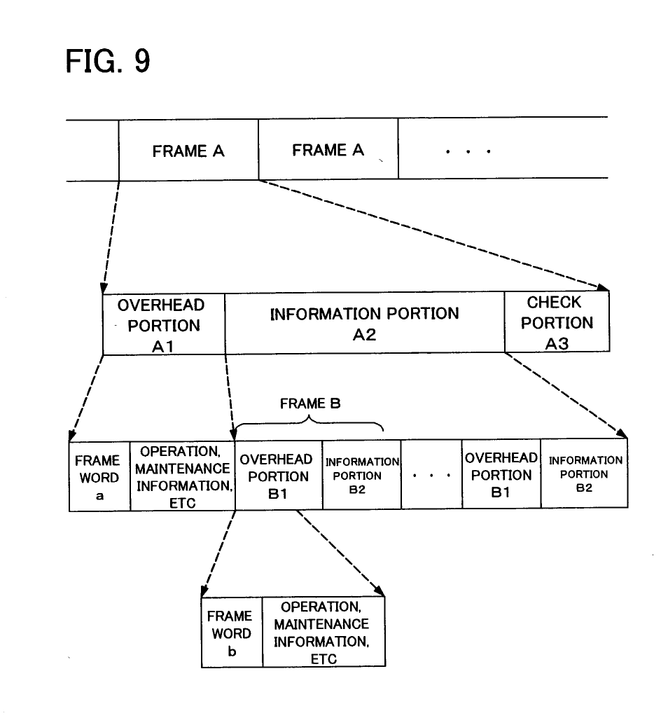

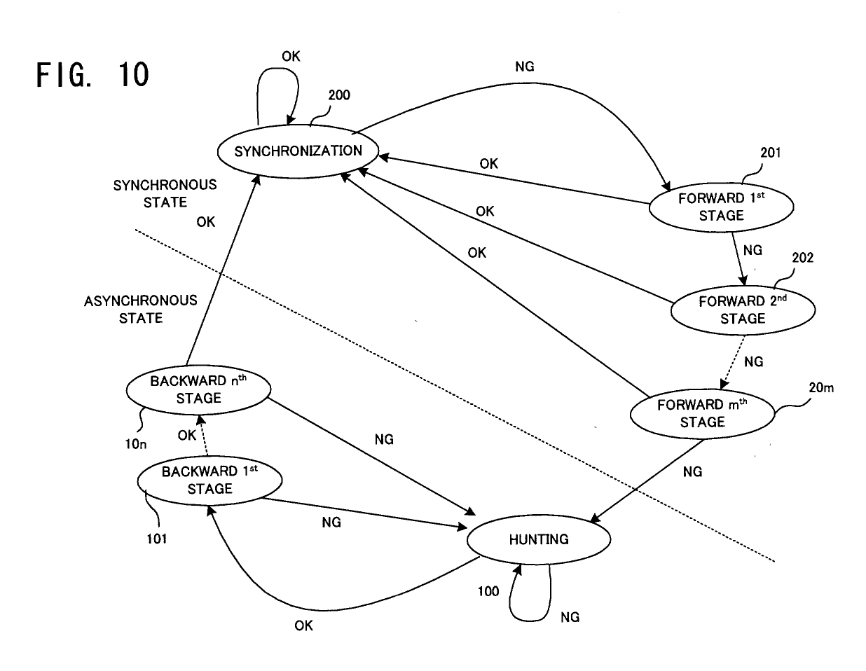

The structure of the frame transmitted from this transmission device 1 is the same as the frame A explained in the Description of the Related Art (see FIG. 9), and so an explanation is here omitted.

The data (original signal) contained in the information portion A2 of the frame A is input to the signal monitor circuit 11. The input data is, for example, data multiplexed in SDH, and comprises one or more frames including an overhead portion B1 and an information portion B2.

After monitoring the state of the input data, the signal monitor circuit 11 sends the data to the speed conversion memory 12. The speed conversion memory 12 is a buffer for adjustment of the transmission speed; data is read from the speed conversion memory 12 to the overhead portion multiplex circuit 14 in accordance with the transmission speed.

On the other hand, additional information contained in the overhead portion A1 is input to the overhead signal interface circuit 13, and is sent via this circuit 13 to the overhead portion multiplex circuit 14.

The overhead portion multiplex circuit 14 multiplexes information bits read from the speed conversion memory 12 and additional information bits sent from the overhead signal interface circuit 13, and generates a frame having the overhead portion A1 and information portion A2. The overhead portion multiplex circuit 14 writes a frame word a sent from the frame word generation circuit 15 at the beginning of the overhead portion A1. Then, the overhead portion multiplex circuit 14 sends the generated frame (overhead portion A1 and information portion A2) to the check bit calculation circuit 16 and the check portion multiplex circuit 17.

The check bit calculation circuit 16 calculates the check bits from the data of the overhead portion A1 and the data of the information portion A2 sent from the overhead portion multiplex circuit 14, and sends the calculation result to the check portion multiplex circuit 17.

The check portion multiplex circuit 17 multiplexes the overhead portion A1 and information portion A2 sent from the overhead portion multiplex circuit 14 with the check bit sent from the check bit calculation circuit 16, and creates the frame A shown in FIG. 9. This frame A is sent to the signal scrambling circuit 18.

The signal scrambling circuit 18 performs scrambling processing on the input frame A using a pseudo-random pattern required in optical transmission, and outputs the result to an optical fiber or similar.

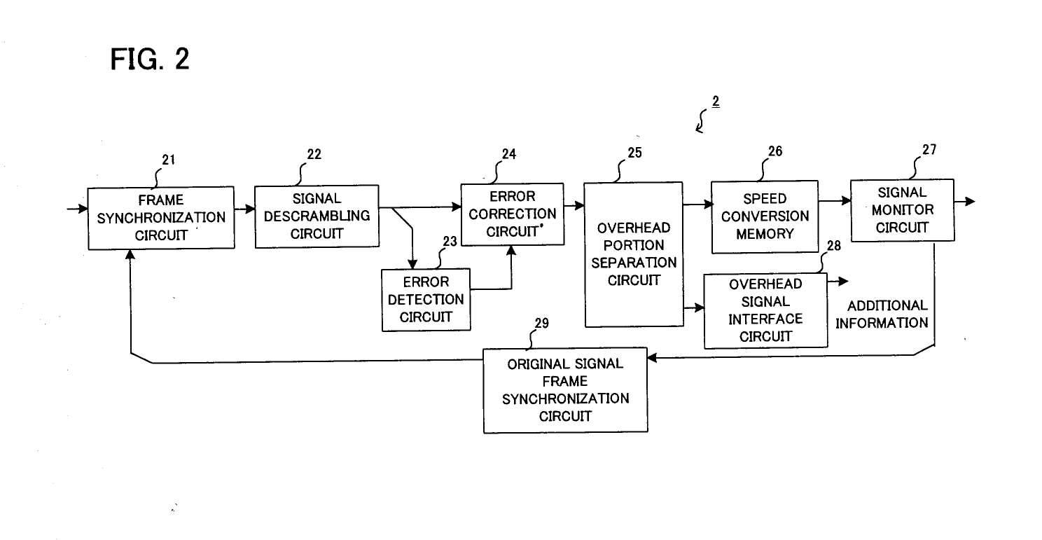

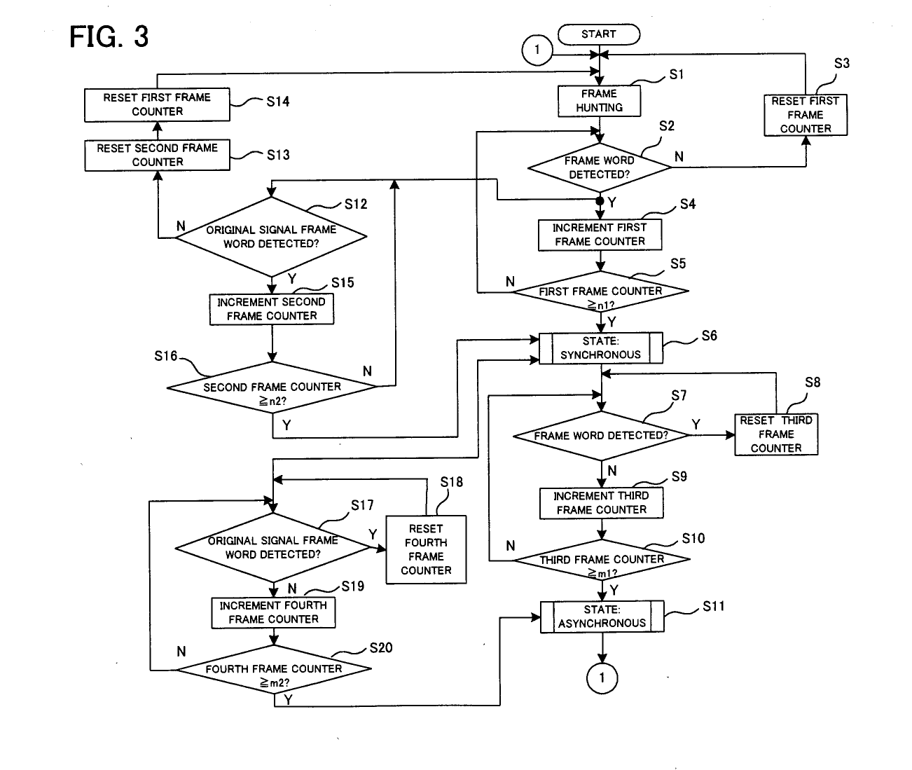

FIG. 2 is a block diagram showing the configuration of the reception device 2 of the first embodiment of the present invention. This reception device 2 receives the frame A from the transmission device 1. FIG. 3 is a flowchart showing the flow of processing of the frame synchronization circuit 21 and original signal frame synchronization circuit 29 of the reception device 2.

This reception device 2 has a frame synchronization circuit 21, signal descrambling circuit 22, error detection circuit 23, error correction circuit 24, overhead portion separation circuit 25, speed conversion memory 26, signal monitor circuit 27, overhead signal interface circuit 28, and original signal frame synchronization circuit 29.

In this embodiment, the frame synchronization circuit 21 executes backward alignment guard processing and forward alignment guard processing based on the frame word a prior to error correction, and the original signal frame synchronization circuit 29 executes backward alignment guard processing and forward alignment guard processing based on the frame word b after error correction. The details of this will be explained below.

The frame synchronization circuit 21 performs frame hunting for a received frame A (step S1), and judges whether the frame word a has been detected in the received signal (step S2).

If the frame word a is not detected (“N” in step S2), the frame synchronization circuit 21 resets the count value of the first frame counter (a counter which counts the number of consecutively detected frames) which the circuit 21 has internally (step S3), and again performs frame hunting (step S1).

On the other hand, if the frame word a is detected (“Y” in step S2), the frame synchronization circuit 21 increments the count value of the first frame counter by one (step S4), and judges whether, after incrementing, the count value of the first frame counter is equal to or greater than the number n1 of backward alignment guard stages set in advance in the circuit 21 (step S5).

Here the number n1 of backward alignment guard stages is set to an appropriate value so that the reception device 2 can change from an asynchronous state to a synchronous state, corresponding to the code error rate of the transmission channel and other characteristics. The actual value is determined based on experiments, simulations, actual applications and similar; as one example, a value of n1=2 might be set.

If the count value of the first frame counter is smaller than the number n1 of backward alignment guard stages (“N” in step S5), the frame synchronization circuit 21 returns to step S2, and judges whether the frame word a is detected at the beginning positions of succeeding frames. If the frame word a is detected at the beginning positions of succeeding frames (“Y” in step S2), the frame synchronization circuit 21 increments the count value of the first frame counter by one (step S4).

When this processing is repeated and the count value of the first frame counter reaches the number n1 of backward alignment guard stages or greater (“Y” in step S5), the reception device 2 changes to a synchronous state (step S6; see state 200 in FIG. 10).

On the other hand, backward alignment guard processing is also executed for the frames B contained in the information portion A2 of the frame A.

In step S2, if the frame word a of the frame A is detected, the frame A is sent to the signal descrambling circuit 22. The signal descrambling circuit 22 restores the frame A, which has been scrambling-processed using a pseudo-random pattern, to the frame A prior to scrambling processing, and sends the restored frame A to the error detection circuit 23 and error correction circuit 24.

The error detection circuit 23 detects whether errors occurring during transmission exist, based on the check portion A3 of the frame A; if errors are detected, the data indicating error correction is sent to the error correction circuit 24.

The error correction circuit 24 corrects the errors existing in the frame A, based on the frame A sent from the signal descrambling circuit 22 and the data indicating error correction sent from the error detection circuit 23. As a result, the check portion A3 is removed from the frame A. The error correction circuit 24 sends the frame A, in which errors have been corrected and from which the check portion A3 has been removed, to the overhead portion separation circuit 25.

The overhead portion separation circuit 25 separates the overhead portion A1 and information portion A2 of the frame A (overhead portion A1 and information portion A2) sent from the error correction circuit 24, sends the overhead portion A1 to the overhead signal interface circuit 28, and sends the information portion A2 to the speed conversion memory 26.

The speed conversion memory 26 is a buffer for adjusting the speed resulting by removing the overhead portion A1 from the frame A; the information portion A2 is read from the speed conversion memory 26 according to the processing speed of the signal monitor circuit 27.

The signal monitor circuit 27 and overhead signal interface circuit 28 are similar respectively to the signal monitor circuit 11 and overhead signal interface circuit 13 in the transmission device 1 of the above-mentioned FIG. 1; and when transmitting to other reception device, a speed conversion memory 12 and overhead portion multiplex circuit 14 and other circuits are provided in the later stages of the circuits 27 and 28.

On the other hand, the information portion A2 is sent from the signal monitor circuit 27 to the original signal frame synchronization circuit 29. The original signal frame synchronization circuit 29 judges whether the frame word b is detected in the frame B (original signal) contained in the information portion A2 (step S12).

When a plurality of frames B are contained in the information portion A2, judgment as to whether the frame word b is detected is performed in sequence starting from the first among the plurality of frames B.

If the frame word b is not detected (“N” in step S12), the original signal frame synchronization circuit 29 resets a second frame counter which the circuit 29 has internally to zero (step S13), and outputs to the frame synchronization circuit 21 a signal to reset the first frame counter of the frame synchronization circuit 21. As a result, the frame synchronization circuit 21 resets the first frame counter to zero (step S14), and again begins frame hunting (step S1).

On the other hand, if the frame word b is detected (“Y” in step S12), the original signal frame synchronization circuit 29 increments the second frame counter by one (step S15). Then the original signal frame synchronization circuit 29 judges whether the count value of the second frame counter after incrementing is equal to or greater than the number n2, set in advance in the circuit 29, of backward alignment guard stages (step S16).

Here the number n2 of backward alignment guard stages is set an appropriate value so that the reception device 2 can change from a synchronous state to an asynchronous state, corresponding to the code error rate of the transmission channel and other characteristics. The actual value is determined based on experiments, simulations, actual operations and similar; as one example, a value of n2=2 might be set. The numbers n1 and n2 of backward alignment guard stages may be set to different values, or may be set to the same value.

When the count value of the second frame counter is smaller than the number n2 of backward alignment guard stages (“N” in step S16), if there exists a succeeding frame B, the original signal frame synchronization circuit 29 judges whether the frame word b is detected at the beginning position of the succeeding frame B (step S12), and either the steps S13 and S14, or the steps S15 and S16, are repeated according to the judgment result.

When the count value of the second frame counter is smaller than the number n2 of backward alignment guard stages (“N” in step S16), if no succeeding frame B exists, processing by the original signal frame synchronization circuit 29 ends, and if the succeeding frame A has been received, processing of a frame B contained in this frame A is begun. When again beginning processing, the original signal frame synchronization circuit 29 can begin processing to reset to zero the second frame counter, or can begin processing in a state in which the former value of the second frame counter is retained.

On the other hand, when the count value of the second frame counter is equal to or greater than the number n2 of backward alignment guard stages (“Y” in step S16), the original signal frame synchronization circuit 29 outputs to the frame synchronization circuit 21 a signal (synchronization establishment signal) indicating a change to a synchronous state.

When the frame synchronization circuit 21 receives this synchronization establishment signal, if the frame synchronization circuit 21 is still in a backward alignment guard state (that is, if in step S5 the count value of the first frame counter is less than n1), the frame synchronization circuit 21 omits backward alignment guard processing (steps S2 to S5), and changes to a synchronous state (step S6). By this means, the reception device 2 changes to a synchronous state (step S6; see state 200 in FIG. 10).

As a result, a change to a synchronous state can be made in a short amount of time. That is, if for example n2 or more frames B are included in one frame A, and by detecting one frame A, n2 or more frame words b can be detected, then by receiving the single frame A, a change to a frame synchronization state can be made.

If the frame synchronization circuit 21 is already in a synchronous state at the time of receiving a synchronization establishment signal, the synchronous state is maintained.

The reception device 2 executes forward alignment guard processing after changing to the synchronous state. First the frame synchronization circuit 21 judges whether the frame word a is detected at the beginning position of the succeeding frame A (step S7).

If the frame word a is detected (“Y” in step S7), the frame synchronization circuit 21 resets to zero the count value of the third frame counter (a counter which counts the number of frames which are not detected consecutively) which the circuit 21 has internally (step S8). Then the frame synchronization circuit 21 returns to step S7, and judges whether the frame word a is detected in the next frame A. At this time, the synchronous state is maintained.

On the other hand, if the frame word a is not detected (“N” in step S7), the frame synchronization circuit 21 increments the third frame counter by one (step S9), and judges whether the count value of the incremented third frame counter is equal to or greater than the number m1, set in advance in the circuit 21, of forward alignment guard stages (step S10).

Here the number m1 of forward alignment guard stages is set to an appropriate value so that the reception device 2 can change from a synchronous state to an asynchronous state, according to the code error rate of the transmission channel and other characteristics. The actual value is determined based on experiments, simulations, actual operations and similar; as one example, a value of m1=4 might be set. The number of forward alignment guard stages m1 and the numbers n1 or n2 of backward alignment guard stages may be set to different values, or may be set to the same value.

If the count value of the third frame counter is smaller than the number m1 of forward alignment guard stages (“N” in step S10), the frame synchronization circuit 21 returns to step S7, and judges whether the frame word a is detected at the beginning position of the succeeding frame A. If the frame word a is not detected at the beginning position of the succeeding frame A (“N” in step S7), the frame synchronization circuit 21 increments by one the count value of the third frame counter (step S9).

When, on repeating such processing, the count value of the third frame counter becomes equal to or greater than the number m1 of forward alignment guard stages (“Y” in step S10), the reception device 2 leaves the synchronous state, and changes to an asynchronous state (see state 100 in FIG. 10).

On the other hand, forward alignment guard is also performed for the frames B contained in the information portion A2 of the frame A.

After changing to the synchronous state (step S6), as explained above, the succeeding received frames A are processed by each of the circuits from the signal descrambling circuit 22 to the signal monitor circuit 27, regardless of whether or not the frame word a is detected in each of these frames A in step S7, and the information portions A2 are sent from the signal monitor circuit 27 to the original signal frame synchronization circuit 29.

The original signal frame synchronization circuit 29 judges whether the frame word b in the frame B contained in the information portion A2 is detected (step S17).

When there are a plurality of frames B contained in the information portion A2, judgment is performed as to whether the frame word b is detected in order, starting from the first of the plurality of frames B.

If the frame word b is detected (“Y” in step S17), the original signal frame synchronization circuit 29 resets to zero a fourth frame counter of the circuit 29 (step S18). If there exists a succeeding frame B, the original signal frame synchronization circuit 29 then repeats the processing of step S17.

On the other hand, if in step S17 the frame word b is not detected (“N” in step S17), the original signal frame synchronization circuit 29 increments the count value of the fourth frame counter by one (step S19), and judges whether the count value of the incremented fourth frame counter is equal to or greater than the number m2, set in advance in the circuit 29, of forward alignment guard stages (step S20).

The number m2 of forward alignment guard stages is set to an appropriate value so that the reception device 2 can change from a synchronous state to an asynchronous state, corresponding to the code error rate of the transmission channel and other characteristics. The actual value is determined based on experiments, simulations, actual applications and similar; as one example, a value of m2=4 might be set. The numbers of forward alignment guard stages m2 may be set to different values, or may be set to the same value. Also, the number m2 of forward alignment guard stages and the numbers n1 and n2 of backward alignment guard stages may be set to different values, or may be set to the same value.

When the count value of the fourth frame counter is smaller than the number m2 of forward alignment guard stages (“N” in step S20), if there exists a succeeding frame B, the original signal frame synchronization circuit 29 judges whether the frame word b is detected at the beginning position of the succeeding frame B (step S17), and according to the judgment result, the processing of either step S18, or of steps S19 and S20 is repeated.

When the count value of the fourth frame counter is smaller than the number m2 of forward alignment guard stages (“N” in step S20), if no succeeding frame B exists, processing by the original signal frame synchronization circuit 29 ends, and when the succeeding frame A is received, processing is again started for the frames B contained in this frame A. When again starting processing, the original signal frame synchronization circuit 29 can reset the fourth frame counter to zero and start processing, or can start processing while retaining the previous value.

On the other hand, when the count value of the fourth frame counter is equal to or greater than the number m2 of forward alignment guard stages (“Y” in step S20), the original signal frame synchronization circuit 29 outputs a signal to the frame synchronization circuit 21 to restart frame hunting, and the reception device 2 changes to an asynchronous state (step S11; see state 100 in FIG. 10). Processing is then repeated again from step S1.

Thus in this embodiment, in frame hunting and backward alignment guard while in an asynchronous state, a judgment is performed as to whether the frame word a is detected in the frame A; if the frame word a is detected, detection of the frame word b in frames B contained in the frame A after error correction is performed. Hence even if a frame word a is detected erroneously as the result of a code error, the frame word b is not detected properly, and so frame synchronization is not established. By this means, pseudo-synchronization is prevented, and frame synchronization is established more reliably.

In this embodiment, even during maintenance of a synchronous state and during forward alignment guard, a judgement is made as to whether the frame word a is detected prior to error correction and whether the frame word b is detected after error correction. If at least one of these is not detected for a number of consecutive frames equal to the number of forward alignment guard stages, the reception device leaves the synchronous state and changes to an asynchronous state. By this means also, pseudo-synchronization is prevented, and frame synchronization is established more reliably.

The first frame counter may be used as the second frame counter as well. In this case, the number n2 of backward alignment guard stages is also used as the number n1 of backward alignment guard stages, and the value of n1 is selected in consideration of this dual use. Also, the processing of step S13 is omitted. The processing of step S15 is performed by having the original signal frame synchronization circuit 29 send the signal which increments the value of the first frame counter to the frame synchronization circuit 21, so that the frame synchronization circuit 21 increments the first frame counter. The frame synchronization circuit 21 performs the processing of step S16.

Similarly, the third frame counter may be used as the fourth frame counter.

Second Embodiment

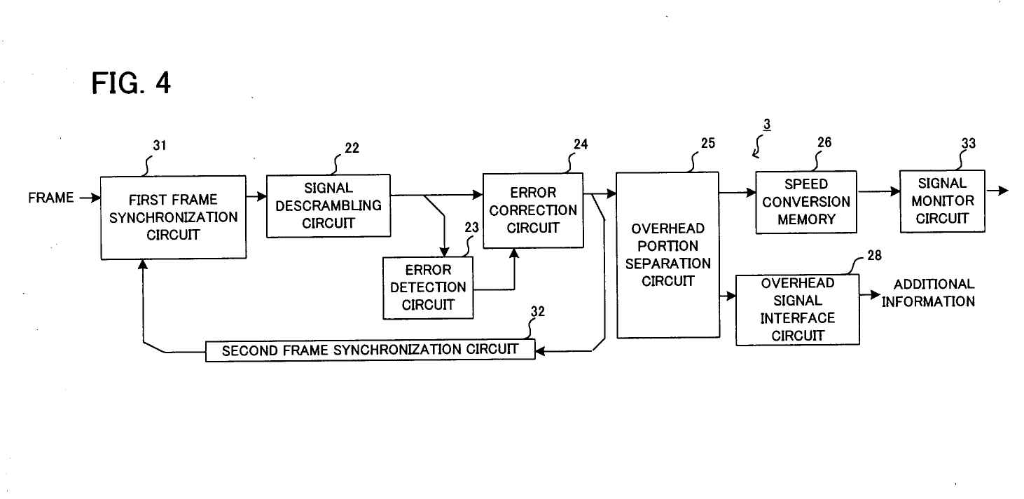

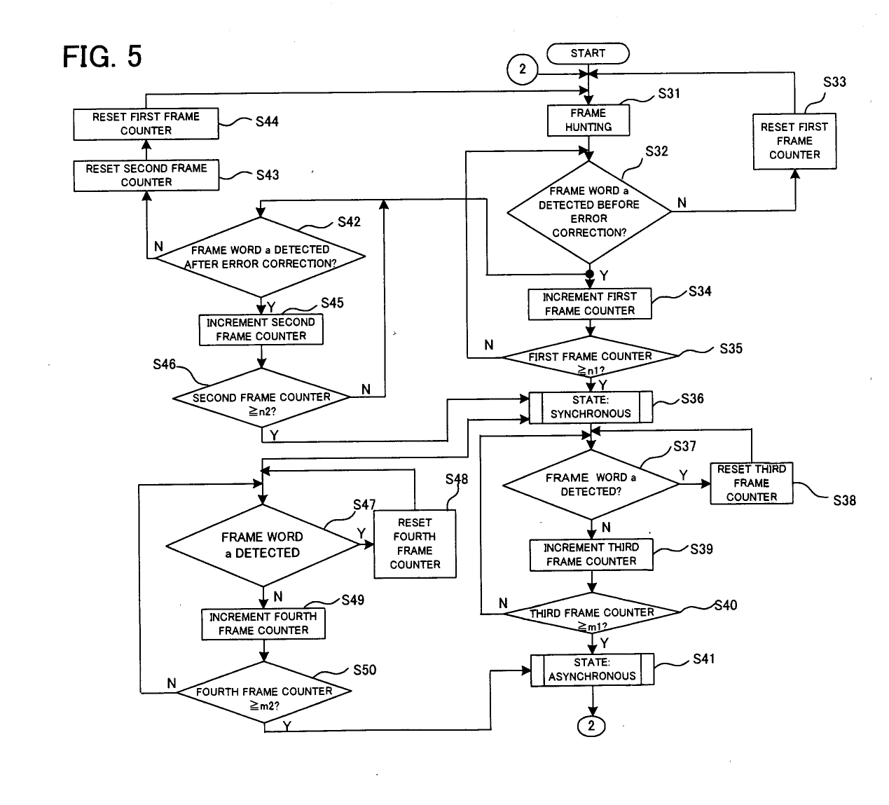

FIG. 4 is a block diagram showing the configuration of reception device 3 in a second embodiment of the present invention. FIG. 5 is a flowchart showing the flow of processing of a first frame synchronization circuit 31 and second frame synchronization circuit 32 of the reception device 3.

The transmission device of this embodiment is the same as that of the above-described first embodiment (see FIG. 1), and so its explanation is omitted. Of the constituent components of the reception device 3, components which are the same as in the reception device 2 (see FIG. 2) of the above-described first embodiment are assigned the same symbols, and their explanations are omitted. As differences in the reception device 3 with respect to the reception device 2, the reception device 3 has a first frame synchronization circuit 31 in place of the frame synchronization circuit 21, a second frame synchronization circuit 32 in place of the original signal frame synchronization circuit 29, and a signal monitor circuit 33 in place of the signal monitor circuit 27.

The signal monitor circuit 33 differs from the signal monitor circuit 27 of the reception device 2 in that the input signal is not output to the original frame synchronization circuit 29. The first frame synchronization circuit 31 and second frame synchronization circuit 32 are explained below.

In this embodiment, the first frame synchronization circuit 31 executes backward alignment guard processing and forward alignment guard processing based on the frame word a prior to error correction. And the second frame synchronization circuit 32 executes backward alignment guard processing and forward alignment guard processing based on the frame word a after error correction. The details of these are explained below.

The first frame synchronization circuit 31 executes the processing of steps S31 to S35. The processing of these steps S31 to S35 is the same as the processing of the respective steps S1 to S5 in the above-mentioned FIG. 3, and so its explanation is omitted. In the case of “Y” in step S35, the reception device 3 changes to a synchronous state (step S36, state 200 in FIG. 10).

In the case of “Y” in step S32, the processing of the first frame synchronization circuit 31 proceeds to step S34, and the received frame A passes through the processing of each of the signal descrambling circuit 22, error detection circuit 23, and error correction circuit 24, and is sent to the second frame synchronization circuit 32. That is, the error-corrected frame A is sent to the second frame synchronization circuit 32.

The second frame synchronization circuit 32 judges whether the frame word a is detected in the overhead portion A1 of the error-corrected frame A (step S42).

If the frame word a is not detected (“N” in step S42), the second frame synchronization circuit 32 resets to zero a second frame counter within the circuit 32 (step S43), and also outputs to the first frame synchronization circuit 31 a signal to reset a first frame counter of the first frame synchronization circuit 31. By this means, the first frame synchronization circuit rests to zero the first frame counter (step S44), and again begins frame hunting (step S31).

On the other hand, when the frame word a is detected (“Y” in step S42), the second frame synchronization circuit 32 increments the second frame counter by one (step S45), and judges whether the count value of the incremented second frame counter is equal to or greater than the number n2, set in the circuit 29 in advance, of backward alignment guard stages (step S16). The number n2 of backward alignment guard stages is equal to the number n1 of backward alignment guard stages in step S35.

If the count value of the second frame counter is smaller than the number n2 of backward alignment guard stages (“N” in step S46), the second frame synchronization circuit 32 waits until the next frame A (error-corrected frame A) is sent from the error correction circuit 24. When the next frame A is sent, the second frame synchronization circuit 32 again starts processing from step S42.

On the other hand, if the count value of the second frame counter is equal to or greater than the number n2 of backward alignment guard stages (“Y” in step S46), the second frame synchronization circuit 32 outputs a synchronization establishment signal to the first frame synchronization circuit 31, and as a result the reception device 3 enters a synchronous state (step S36; see state 200 in FIG. 10).

After entering the synchronous state, the reception device 3 executes forward alignment guard processing. Initially, the first frame synchronization circuit 31 executes the processing of steps S37 to S40. This processing is the same as the processing of the respective steps S7 to S10 in the above-mentioned FIG. 3, and so its explanation is here omitted. In the case of “Y” in step S40, the reception device 3 enters an asynchronous state (step S41, state 100 in FIG. 10).

Similarly, the second frame synchronization circuit 32 also executes forward alignment guard processing. The received frame A is processed by each of the signal descrambling circuit 22, error detection circuit 23 and error correction circuit 24, regardless of whether the frame word a is detected in this frame A in step S37, and is sent to the second frame synchronization circuit 32. That is, the error-corrected frame A is sent to the second frame synchronization circuit 32.

The second frame synchronization circuit 32 judges whether the frame word a is detected in the overhead portion of the error-corrected frame A (step S42).

If the frame word a is detected (“Y” in step S47), the second frame synchronization circuit 32 resets to zero the fourth frame counter of the circuit 32 (step S43), and waits until the next frame A (error-corrected frame A) is sent from the error correction circuit 24. When the next frame A is sent, the second frame synchronization circuit 32 again starts processing from step S47.

On the other hand, if the frame word a is not detected (“N” in step S42), the second frame synchronization circuit 32 increments the fourth frame counter by one, and judges whether the count value of the incremented fourth frame counter is equal to or greater than the number m2, set in the circuit 32 in advance, of forward alignment guard stages (step S50). The number m2 of forward alignment guard stages is equal to the number m1 of backward alignment guard stages in step S35.

If the count value of the fourth frame counter is smaller than m2 (“N” in step S50), the sending of the next error-corrected frame A from the error correction circuit 24 is awaited, and processing is repeated from step S47. On the other hand, if the count value of the fourth frame counter is less than m2 (“Y” in step S50), the reception device 3 changes to an asynchronous state (step S41; see state 100 in FIG. 10). Then, processing is repeated from step S32.

In this way, in this embodiment, backward alignment guard processing and forward alignment guard processing are performed for the frame word a prior to error correction and for the frame word a after error correction. By this means, pseudo-synchronization is prevented, and frame synchronization is performed more reliably.

Similarly to the case of the first embodiment, the first frame counter may also be used as the second frame counter.

Third Embodiment

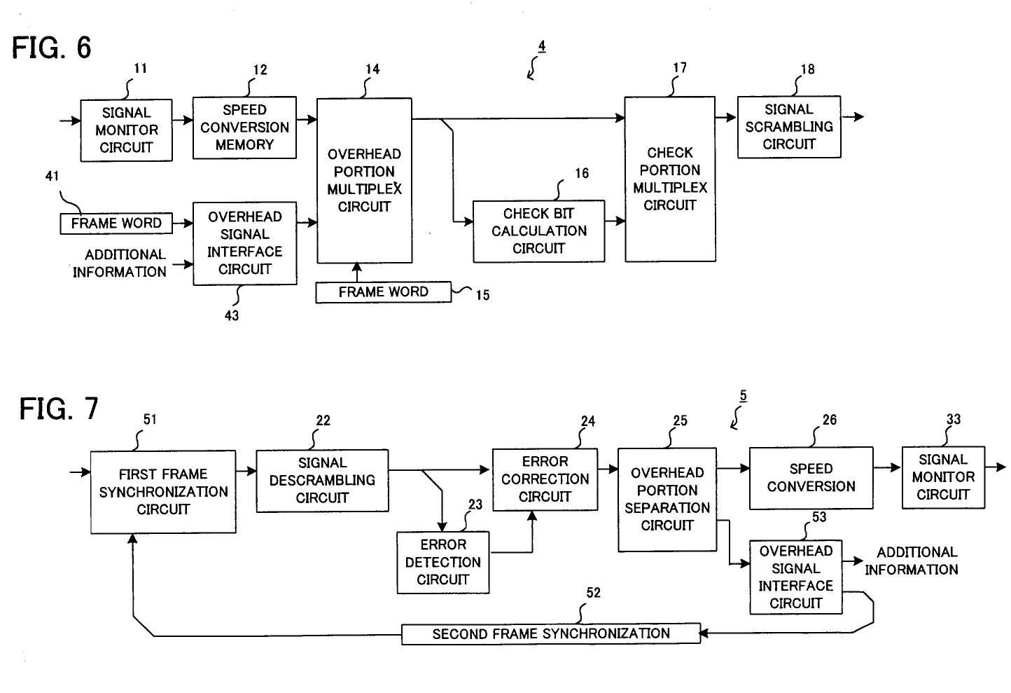

FIG. 6 is a block diagram showing the configuration of the transmission device 4 of a third embodiment of this invention. Of the constituent components of the transmission device 4, components which are the same as in the transmission device 1 (see FIG. 1) of the above-described first embodiment are assigned the same symbols, and their explanations are omitted. As differences in the transmission device 4 with respect to the transmission device 1, the transmission device 4 further has a frame word generation circuit 41, and also has an overhead signal interface circuit 42 in place of the overhead signal interface circuit 13.

The frame word generation circuit 41 generates a frame word c, which is sent to the overhead signal interface circuit 42. The frame word c may be the same as the frame word a, but preferably is different.

The overhead signal interface circuit 42 positions (writes) the frame word c in a predetermined position (different from the position of the frame word a) in the overhead portion (additional information) A1, and sends this overhead portion A1 to the overhead portion multiplex circuit 14. As explained above, the overhead portion multiplex circuit 14 writes the frame word a sent from the frame word generation circuit 15 at the beginning of the overhead portion A1. As a result, the overhead portion A1 contains the frame words a and c, and a frame A containing both frame words is transmitted from the transmission device 4.

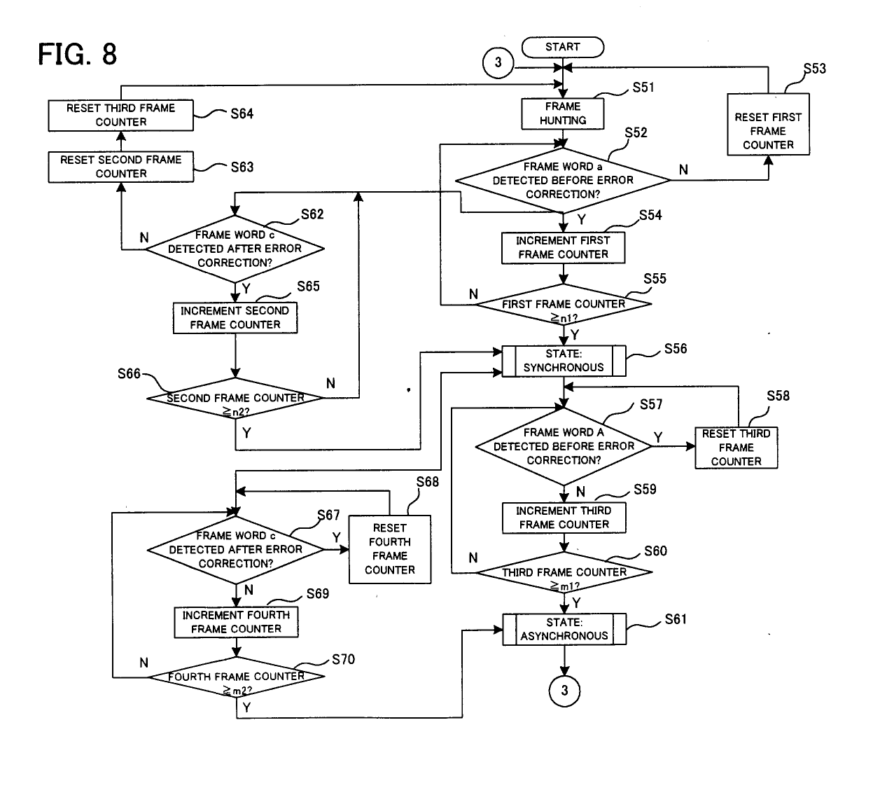

FIG. 7 is a block diagram showing the configuration of the reception device 5 of the third embodiment of this invention. This reception device 5 receives the frame A from the transmission device 4. FIG. 8 is a flowchart showing the flow of processing of the first frame synchronization circuit 51 and second frame synchronization circuit 52 of the reception device 5.

Of the constituent components of the reception device 5, components which are the same as in the reception device 2 (see FIG. 2) of the above-described first embodiment, or the same as in the reception device 3 (see FIG. 4) of the second embodiment, are assigned the same symbols, and their explanations are omitted.

In this embodiment, the first frame synchronization circuit 51 executes backward alignment guard processing and forward alignment guard processing based on the frame word a prior to error correction, and the second frame synchronization circuit 52 executes backward alignment guard processing and forward alignment guard processing based on the frame word c after error correction. The details of this are explained below.

The first frame synchronization circuit 51 executes the processing of steps S51 to S55. The processing of these steps S51 to S55 is the same as the processing of the respective steps S1 to S5 in the above-mentioned FIG. 3 (and the processing of the steps S31 to S35 in FIG. 5), and its explanation is omitted. In the case of “Y” in step S55, the reception device 3 changes to a synchronous state (step S56, state 200 in FIG. 10).

In the case of “Y” in step S52, the processing of the first frame synchronization circuit 51 proceeds to step S54, and the received frame A passes through the processing of each of the signal descrambling circuit 22, error detection circuit 23, error correction circuit 24, and overhead portion separation circuit 25, and the overhead portion A1 of the frame A is sent to the second frame synchronization circuit 52. That is, the error-corrected overhead portion A1 is sent to the second frame synchronization circuit 52.

The second frame synchronization circuit 52 executes backward alignment guard processing for the frame word c written at a predetermined position in the error-corrected overhead portion A1 (steps S62 to S66). Except for the fact that the object of detection is the frame word c, the processing of these steps S62 to S66 is the same as that of the steps S42 to S46 in FIG. 5, in which the object of detection is the frame word a. Hence its explanation is here omitted.

In this way, frame synchronization is established based on the frame word a and the frame word c, and the reception device 5 changes to a synchronous state (step S36).

After the change to a synchronous state, forward alignment guard processing is executed (steps S57 to S60 and S67 to S70). The processing of steps S57 to S60 is the same as the processing of the respective steps S7 to S10 in FIG. 3 (and also the processing of steps S37 to S40 in FIG. 5), and so an explanation is here omitted. Also, except for the fact that the object of detection is the frame word c, the processing of steps S67 to S70 is the same as the processing of the respective steps S47 to S50 in FIG. 5, in which the object of detection is the frame word a; hence an explanation is here omitted.

Thus in this embodiment, frame synchronization is performed based on the frame words a and c contained in the overhead portion A1. Hence pseudo-synchronization is prevented, and frame synchronization can be performed more reliably.

A plurality of frame words c may be incorporated in prescribed positions in the overhead portion A1. In this case, steps S62 to S66 perform detection of a plurality of frame words c for a single frame A.

Other Embodiments

The reception device 2, 3 and 5 in the first through third embodiments described above may be portions of relay device which receives frames and retransmits the frames to other device. Also, the transmission device 1 and 4 may also be portions of such relay device.

The embodiments described above are examples, and do not limit the technical scope of this invention.

By means of this invention, the beginning position of a frame can be detected more accurately, frame synchronization can be performed more reliably, and the occurrence of pseudo-synchronization (erroneous synchronization) states can be prevented.

What is claimed is:

1. A frame synchronization device, which receives data communicated on a transmission line and establishes frame synchronization by means of frames containing, at least, first and second synchronization data for establishing frame synchronization and check data for correcting errors of data in the frame, said first and second synchronization data being disposed at prescribed positions within the frame, comprising:
a first frame synchronization unit for attempting to detect said first synchronization data within said received data in a frame hunting state in which frame synchronization is not established, and entering a synchronous state in which frame synchronization is established when said first synchronization data is detected in said prescribed position for a first predetermined number of consecutive frames;
an error correction unit for correcting errors of data in the frame based on said check data in the frame when said first synchronization data is detected by said first frame synchronization unit; and
a second frame synchronization unit for attempting to detect said second synchronization data at said prescribed position within the frame corrected by said error correction unit, and returning said first synchronization unit to said frame hunting state when said second synchronization data is not detected.

2. The frame synchronization device according to claim 1, wherein said second frame synchronization unit changes said first frame synchronization unit to the synchronous state when the number of said second synchronization data detected consecutively is equal to or greater than a second predetermined number.

3. The frame synchronization device according to claim 1, wherein:
said first frame synchronization unit attempts to detect said first synchronization data at the prescribed position of the received frame in the synchronous state, and enters the frame hunting state when the first synchronization data is not detected for a third predetermined number of consecutive frames; and
said second frame synchronization unit attempts to detect said second synchronization data at the prescribed position in the received frame corrected by said error correction unit, and puts said first synchronization unit into said frame hunting state when a fourth predetermined number of said second synchronization data is/are not detected consecutively.

4. A frame synchronization device, which receives data communicated on a transmission line and establishes frame synchronization by means of frames containing, at least, first and second synchronization data for establishing frame synchronization and check data for correcting errors of data in the frame, said first and second synchronization data being disposed at prescribed positions within the frame, comprising:
a first frame synchronization unit for attempting to detect said first synchronization data at said prescribed position in said received frame in a synchronous state in which frame synchronization is established, and entering an asynchronous state in which frame synchronization is not established when said first synchronization data is not detected for a first predetermined number of consecutive frames;
an error correction unit for correcting code errors of data in said received frame based on said check data in the frame; and,
a second frame synchronization unit for attempting to detect said second synchronization data at said prescribed position in the frame corrected by said error correction unit, and putting said first synchronization unit into said asynchronous state when a second predetermined number of said second synchronization data is/are not detected consecutively.

5. The frame synchronization device according to claim 1, wherein
said frame has an overhead portion containing control data and an information portion containing user data, and
said first synchronization data is positioned in said overhead portion, and one or more of said second synchronization data are positioned in said information portion.

6. The frame synchronization device according to claim 1, wherein
said frame has an overhead portion containing control data, and
said first and second synchronization data are positioned at different positions in said overhead portion.

7. A frame synchronization device, which receives data communicated on a transmission line and establishes frame synchronization by means of frames containing, at least, a synchronization data for establishing frame synchronization and check data for correcting errors of data in the frame, said synchronization data being disposed at a prescribed position within the frame, comprising:
a first frame synchronization unit for attempting to detect said synchronization data within said received data in a frame hunting state in which frame synchronization is not established, and entering a synchronous state in which frame synchronization is established when said synchronization data is detected at said prescribed position for a first predetermined number of consecutive frames;
an error correction unit for correcting errors of data in the frame having the detected synchronization data based on said check data in the frame if said synchronization data is detected by said first frame synchronization unit; and
a second frame synchronization unit for attempting to detect said synchronization data at said prescribed position in the frame corrected by said error correction unit, and returning said first synchronization unit to said frame hunting state if said synchronization data is not detected.

8. The frame synchronization device according to claim 7, wherein
said first frame synchronization unit attempts, in said synchronous state, to detect said synchronization data at said prescribed position of said received frame, and, when said synchronization data is not detected for a second predetermined number of consecutive frames, enters said frame hunting state; and,
said second frame synchronization unit attempts to detect said synchronization data at said prescribed position in the frame after correction of said received frame by said error correction unit, and, when said synchronization data is not detected for a third predetermined number of consecutive frames, puts said first synchronization data unit into said frame hunting state.

9. A frame synchronization device, which receives data communicated on a transmission line and establishes frame synchronization by means of frames containing, at least, a synchronization data for establishing frame synchronization and check data for correcting errors of data in the frame, said synchronization data being disposed at a prescribed position within the frame, comprising:
a first frame synchronization unit for attempting to detect said synchronization data at said prescribed position of said received frame in a synchronous state in which frame synchronization is established, and entering an asynchronous state in which frame synchronization is not established when said synchronization data is not detected for a predetermined number of consecutive frames;
an error correction unit for correcting errors of data in said received frame based on said check data in the frame; and
a second frame synchronization unit for attempting to detect said synchronization data at said prescribed position in the frame corrected by said error correction unit, and putting said first synchronization unit into said asynchronous state when said synchronization data is not detected for said predetermined number of consecutive frames.

10. A frame synchronization method, performed by reception device which receives data communicated on a transmission line and establishes frame synchronization by means of frames containing, at least, first and second synchronization data for establishing frame synchronization and check data for correcting errors of data in the frame, said first and second synchronization data being disposed at prescribed positions within the frame, comprising steps of:
attempting to detect said first synchronization data in said received data in a frame hunting state in which frame synchronization is not established, and entering a synchronous state in which frame synchronization is established when said first synchronization data is detected at said prescribed position for a first predetermined number of consecutive frames;
correcting errors of the data in the frame having said detected first synchronization data based on said check data in the frame; and
attempting to detect said second synchronization data at said prescribed position in said corrected frame, and returning to said frame hunting state when said second synchronization data is not detected.

11. A frame synchronization method, performed by reception device, which receives data communicated on a transmission line and establishes frame synchronization by means of frames containing, at least, first and second synchronization data for establishing frame synchronization and check data for correcting errors of data in the frame, said first and second synchronization data being disposed at prescribed positions within the frame, comprising steps of:
attempting to detect said first synchronization data at said prescribed position in said received frame in a synchronous state in which frame synchronization is established, and entering asynchronous state in which frame synchronization is not established when said first synchronization data is not detected for a first predetermined number of consecutive frames;
correcting errors of the data in said received frame based on said check data in the frame; and
attempting to detect said second synchronization data at said prescribed position in said corrected frame, and entering said asynchronous state when said second synchronization data is not detected for a second number of consecutive frames.

12. A frame synchronization method, performed by reception device which receives data communicated on a transmission line and establishes frame synchronization by means of frames containing, at least, a synchronization data for establishing frame synchronization and check data for correcting errors of data in the frame, said synchronization data being disposed at a prescribed position within the frame, comprising steps of:
attempting to detect said synchronization data within said received data in a frame hunting state in which frame synchronization is not established, and entering a synchronous state in which frame synchronization is established when said synchronization data is detected at said prescribed position for a first predetermined number of consecutive frames;
correcting errors of the data in the frame having said detected synchronization data based on said check data in the frame when said synchronization data is detected; and
attempting to detect said synchronization data at said prescribed position in said corrected frame, and, returning to said frame hunting state when said synchronization data is not detected.

13. A frame synchronization method, performed by reception device which receives data communicated on a transmission line and establishes frame synchronization by means of frames containing, at least, a synchronization data for establishing frame synchronization and check data for correcting errors of data in the frame, said synchronization data being disposed at a prescribed position within the frame, comprising steps of:
attempting to detect said synchronization data at said prescribed position in said received frame in a synchronous state in which frame synchronization is established, and entering an asynchronous state in which frame synchronization is not established when said synchronization data is not detected for a predetermined number of consecutive frames;
correcting errors of the data in said received frame based on said check data in the frame; and
attempting to detect said synchronization data at said prescribed position in said corrected frame, and entering said asynchronous state when said synchronization data is not detected for said predetermined number of consecutive frames.
